(19) United States
(12) Patent Application Publication
(10) Pub. No.: US 2009/0183102 A1
(43) Pub. Date: Jul. 16, 2009

(54) METHOD FOR ANNOTATING A PROCESS

(75) Inventors: Milton H. Hernandez, Tenafly, NJ (US); Hani T. Jamjoom, White Plains, NY (US); Arjun Natarajan, Old Tappan, NJ (US); Thirumal R. Nellutla, Schaumburg, IL (US); Sreeram Ramakrishnan, Yorktown Heights, NY (US); Debanjan Saha, Mohegan Lake, NY (US); Ramendra K. Sahoo, Mohegan Lake, NY (US); Anees A. Shaikh, Yorktown Heights, NY (US); Mithkal M. Smadi, Round Rock, TX (US)

Correspondence Address: RYAN, MASON & LEWIS, LLP, 1300 POST ROAD, SUITE 205, FAIRFIELD, CT, 06824, US

(73) Assignee: International Business Machines Corporation, Armonk, NY (US)

(21) Appl. No.: 12/015,020

(22) Filed: Jan. 16, 2008

(51) Int. Cl. G06F 3/048

(52) U.S. Cl. 715/771

(57) ABSTRACT

Techniques for annotating a process are provided. The techniques include identifying one or more annotation areas, obtaining one or more items of service process information, identifying one or more annotation attributes, and using the one or more annotation areas, one or more items of service process information and one or more annotation attributes to annotate a process. Techniques are also provided for creating an interactive mechanism.

### FIELD OF THE INVENTION

The present invention generally relates to information technology, and, more particularly, to information technology (IT) related processes.

### BACKGROUND OF THE INVENTION

Enterprise and information technology (IT) processes (as well as transactions) are customarily captured through process monitoring and modeling tools such as, for example, WebSphere Business Integration (WBI) modeler, Aqualogic, Visio, etc. However, in order to make sure that the processes captured are useful and compliant with other mechanisms (such as, for example, lean, delivery management, best practices as well as quality), a number of requirements need to be satisfied to expedite realization within service lines and competencies. Such targets may address problems such as, for example, implementation being expensive due to specific variations among different accounts, variations in review, access to input/output (1/O) and deliverable requirements posing training and learning challenges for new entrants to the area, high level report generation, tracking and auditing requiring manual processing, and analysis and review of a significant number of documents, reports and status update spreadsheets.

As a result, in order to expedite services delivery and process realization, it is required to annotate the processes with not only sufficient input, output and delivery requirements, but also with tight mapping among standardized tasks, role players, apart from example charts, templates, URL links, etc. in order to make the task steps self-contained. Moreover, whenever it is required to determine the places (within the process or resources) where there are bottlenecks, it becomes a cumbersome task to ascertain the details. Eventually, existing approaches are customized to specific accounts, process level details, or even role-played by certain competencies. Such approaches are universally difficult to be used as a general mechanism or technique across a number of accounts.

In existing approaches, these enterprise processes (usually represented as process models using any of the standard process modeling and integration tools such as Websphere business modeler, Aqualogic, etc.) are static view graphs with a limited number of information available for the steps within a process. Similarly, due to the absence of any common guidelines about what a process model should contain, the type of information available within a typical process can vary widely, resulting in a varied range of process planning, organization and even optimization for the same process. Also, due to the nature of processes, the quality of service provided to the customers can also vary. However, too much information as a part of a typical process can confuse the process implementers due to a stiff learning process associated with each of the tasks.

A typical process has sub-processes, and a sub-process can have a group of tasks with some tasks having sub-tasks and so on. Also, several documents, charts, tools and role players can be associated with a task. IT services as enterprise processes are not necessarily optimized to accommodate the constantly changing enterprise needs to new types of customers and their requirements. Further, emergence of new enterprise demands and fast-changing technology imposes a time and resource crunch to meet market demands. The enterprise processes need to be fairly competitive and optimized to provide a return on investment (ROI) within a very short span of time with minimal resource utilization. However, due to the absence of any standardized norms such as “what a process, task or sub-task should contain,” the process and tasks cannot be declared sufficient for any operation management deployment.

Existing enterprise processes (termed as best practices) are not “the best” representation of the processes, as they include inadequate information available for wide variety of processes. Several similar processes are termed as different processes due to “targeted” customer needs leading to each process representing a “customized process assembly line.” Static processes (with a combination of series of tasks) make the process annotation leading to process optimization and standardization of process quite complex and labor intensive. Static organization of processes with inadequate knowledge representation lead to difficulties in locating and duplicating tasks with different names and a wide variety of inputs, outputs and association with other tasks.

Lean principles can be used, for example, in manufacturing and, more recently, in IT services. Objectives of applying lean in IT include, for example, leveraging global footprint, skills and technology to create competitive advantages, aggressively driving productivity through lean, building organizational capabilities to continually drive and sustain improvements within IT organization through the creation of experienced lean change agents and/or champions, and establish robust infrastructure to drive ongoing and incremental improvements.

Lean implementation durations have been significantly compressed. Consequently, lean process efficiency must be increased in response. Also, lean consultancy resources are increasingly limited. Engagement managers need tools to complete more leanings with fewer resources. Lean effort often requires information specific to each competency, service line, or account. As such, lean practitioners need ready access to authoritative process and documentation.

The absence of an integrated mechanism leads to standardizing such processes through consolidated requirements. The absence of an integrated mechanism also hinders implementation plans, while imposing serious challenges on training the new entrants within a short span of time.

Lean principles, being new to IT services, have a wide range of philosophical, organizational and operational variations compared to conventional manufacturing processes. The nature of logistics, process supply chain management, execution and delivery could lead to the introduction of a number of confusions, because IT processes are difficult to capture in a way that would be equivalent to a manufacturing process.

The lean, as a set of principles, is not new to IT and other services organizations to eliminate waste, while segmenting complexity and measurements through continual diagnosis and end-state designs. For an increasing number of organizations, IT services and processes control a significant part of their revenue. For an IT organization, it is advantageous to have a structured organization of the different forms, templates and work procedures available for leaning the processes, steps and resources in order to optimize enterprise performance.

With globalization and availability of resources, labor and on-demand process planning and execution, it is advantageous to have a lean process applied to an IT industry within a short period of time. Such a system would enable the industries to remain competitive while not only delivering exactly what the customers look for, but also optimize the usage of resources.

Existing approaches to implement lean in an IT organization have several limitations and inefficiencies. For example, lean implementations are bounded by documents, charts and templates with no centralized or structured way to look at the procedural details. Also, existing techniques are expensive to progress account-by-account due to specific variations. Existing approaches are also devoid of standard lean implementation reviews, and access to inputs, outputs and deliverables, thus introducing training and leaning challenges for new entrants. Further, existing approaches require manual processing, tracking and auditing of a significant number of documents in order to prepare and generate high level reports.

Additionally, existing approaches do not map lean work plans to defined tasks, required inputs, outputs, standardized forms and templates to accelerate training of the associates to track, collaborate and provide feedbacks to implementation work plans. Existing techniques also do not include procedures to consolidate, isolate or even prepare role player-specific or account-specific views, reports etc., including possible automatic tracking of the implementation status. Further, existing approaches do not include mechanism to prevent sharing and control of a significant amount of account, service-line-specific sensitive information, as all of the details are open and available to all involved parties.

### SUMMARY OF THE INVENTION

Principles of the present invention provide techniques for annotating a process. An exemplary method (which may be computer-implemented) for creating an interactive mechanism, according to one aspect of the invention, can include steps of preparing one or more lean principles as a process model, annotating the process model with one or more items of process information, and using the process model to create an interactive mechanism, wherein the interactive mechanism comprises one or more process details.

In an embodiment of the invention, an exemplary method for annotating a process includes the following steps. One or more annotation areas are identified. One or more items of service process information are obtained. One or more annotation attributes are identified. Also, the annotation areas, items of service process information and annotation attributes are used to annotate a process.

At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating a skeletal presentation of current process and associated steps represented as IT or enterprise processes, according to an embodiment of the present invention;

FIG. 2 is a diagram illustrating a set of forms and documents in one representation of lean activity, according to an embodiment of the present invention;

FIG. 3 is a flow diagram illustrating techniques for capturing lean processes, according to an embodiment of the present invention;

FIG. 4 is a diagram illustrating an exemplary grouping of tasks followed by annotation stages, according to an embodiment of the present invention;

FIG. 5 is a diagram illustrating necessary criteria for process annotation, according to an embodiment of the present invention;

FIG. 6 is a diagram illustrating sufficient criteria for process annotation, according to an embodiment of the present invention;

FIG. 7 is a diagram illustrating a service process annotation matrix, according to an embodiment of the present invention;

FIG. 8 is a diagram illustrating exemplary service process annotation, according to an embodiment of the present invention;

FIG. 9 is a flow diagram illustrating techniques for annotating a process, according to an embodiment of the present invention;

FIG. 10 is a diagram illustrating exemplary configuration settings, according to an embodiment of the present invention;

FIG. 11 is a diagram illustrating an interactive journal layout, according to an embodiment of the present invention;

FIG. 12 is a diagram illustrating an exemplary interactive mechanism to add and delete changes with keeping a log of the changes, according to an embodiment of the present invention;

FIG. 13 is a diagram illustrating a change log representing collaborative details with actions, according to an embodiment of the present invention;

FIG. 14 is a flow diagram illustrating techniques for creating an interactive mechanism, according to an embodiment of the present invention; and

FIG. 15 is a system diagram of an exemplary computer system on which at least one embodiment of the present invention can be implemented.

### DETAILED DESCRIPTION OF PREFERRED EMBODIMENTS

Principles of the present invention include transforming any IT or enterprise process and representation of these processes with sufficient structured, hierarchical with options to collaborate and interact within each of the processes context while executing and deploying such processes as an interactive manual. Principles of the invention also include transformation and establishment of lean principles and associated best practices as an interactive and collaborative work manual by modeling the steps as enterprise processes. One or more embodiments of the present invention includes focusing the steps within lean principles as operational definitions, and assigning well-defined and bounded procedures, inputs and deliverables for each step of a lean operation. Additionally, one or more embodiments of the invention includes analyzing IT processes based on lean definitions, while establishing and preparing lean work procedures as a work manual and/or interactive journal (for example, a lean journal). Also, principles of the present invention include annotating a task, sub-process and/or process by way of a well-defined set of necessary and sufficient requirements.

An enterprise process model, as described herein, may include tight mapping of tasks, process and clusters, as well as other details. As noted above, existing leap implementation plans for an organization are carried out through consulting professionals (either in-house or hired from outside). Moreover, since a lean implementation is a continually improving technique, the process and task details preferably constantly evolve, while minimizing the effect of changes to the lean enterprise process execution.

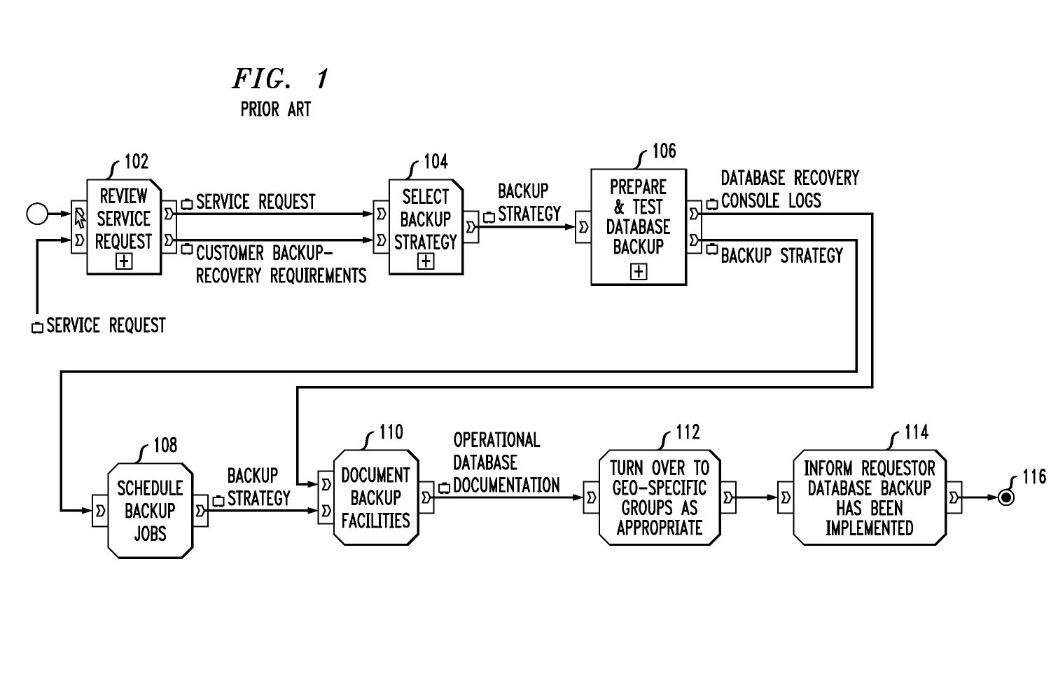

FIG. 1 is a diagram illustrating a skeletal presentation of current process and associated steps represented as IT or enterprise processes, according to an embodiment of the present invention. By way of illustration, FIG. 1 depicts a typical process chain with a number of sub-processes and tasks. At the highest level, any process constitutes a number of sub-processes which are typically in-line with any generic industrial and manufacturing process. FIG. 1 includes exemplary steps include reviewing a service request 102, selecting a backup strategy 104, preparing and testing a database backup 106, scheduling backup jobs 108, using document backup facilities 110, turning over to geo-specific control groups as appropriate 112 and informing the requestor that the database backup has been implemented 114. Element 116 represents the end of the above-described process.

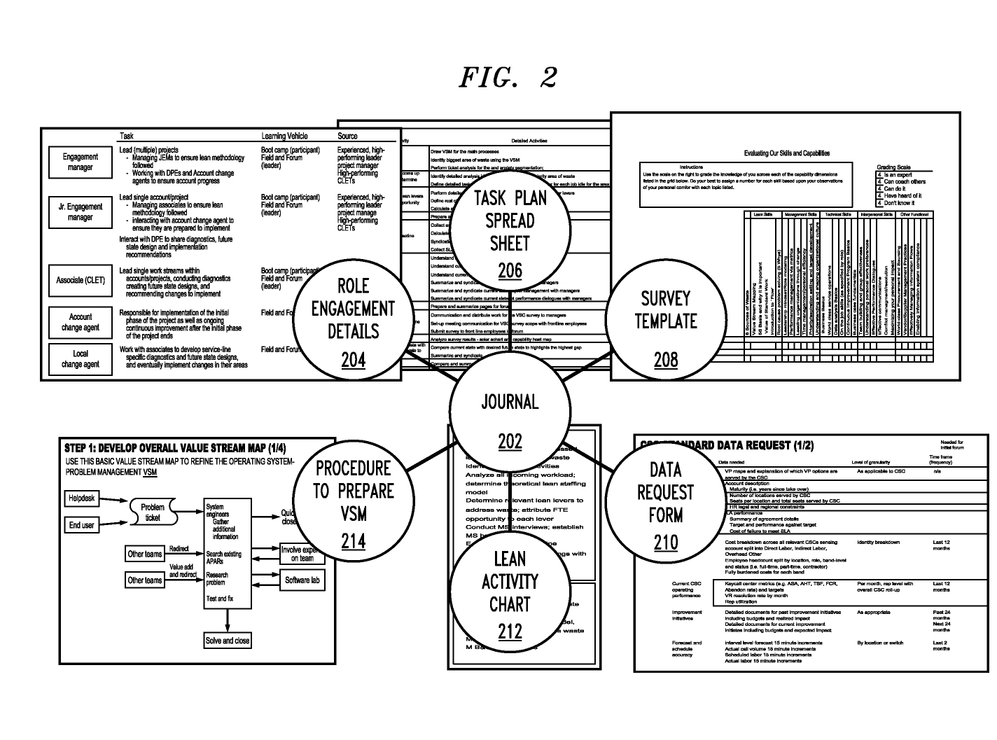

FIG. 2 is a diagram illustrating a set of forms and documents in one representation of lean activity, according to an embodiment of the present invention. FIG. 2 refers to existing approach steps in a lean mechanism applied to IT service processes. By way of illustration, FIG. 2 depicts the elements of a journal 202 (for example, a lean journal), role enlargement details 204, task plan spreadsheet 206, survey template 208, data request form 210, lean activity chart 212 and procedure to prepare value stream mapping (VSM) 214.

FIG. 2 refers to existing approach steps in a lean mechanism applied to IT service processes. Typically, a lean plan has four phases including a pre-work phase, a diagnostics phase, an end-state design phase and an implementation phase. Each phase can be a combination of various activities, while each activity can have multiple process steps with associated documents and deliverables. FIG. 2 is an illustration of various types of forms and associated activities that can be considered towards organizing and preparing a structured list of activities with well-defined inputs, outputs and deliverables. Each of the phases can include a wide range of activities, inputs and deliverables. Moreover, activities within each of the phases can be considered to belong to one of three work streams such as, for example, operating system, management system, and mind behavior and capabilities. As depicted herein, FIG. 2 includes a sample of different activities which are part of lean phases.

One or more embodiments of the present invention, however, include converting lean principles as transformed enterprise processes to accelerate the operations with continuous improvement. Also, the techniques described herein significantly cut down the time needed to implement lean through standardized step by step evaluation, annotation and review techniques. Additionally, one or more embodiments of the invention capture, track and collaborate lean implementations as an enterprise process for different accounts or cluster of accounts, while reporting specific changes in processes, roles and lean service lines in a structured manner. Also described herein is a consolidated view of measurable improvements resulting in a decrease in deployment time and service level agreement attainment gains.

One or more embodiments of the invention also provide a defined structured process model with tight mapping of tasks, accounts, clusters, and links and associated role player details. Each task can be, for example, in a self contained state with I/O contents, forms templates and account specific requirements. As detailed herein, a consolidated lean review, access to I/O and deliverable requirements help new entrants to learn and get trained within a shorter time period.

Structured data, tightly coupled processes, roles, accounts, and competencies enhance automatic tracking and on-demand report generation. Additionally, one or more embodiments of the present invention include parallel or sequential work-streams within each phase with detailed steps, as well as a scope to customize and prepare reports on-the-fly for competency-specific or account-specific needs. The techniques described herein also provide built-in support for collaboration, seeking assistance, interfaces for subject matter experts to respond to queries, and integrated contact information with links to role-players with organization hierarchy.

Applying lean principles as transformed enterprise processes accelerates the operations with continuous improvement, and significantly cuts down the time taken to implement lean through standardized step by step evaluation, annotation and review techniques.

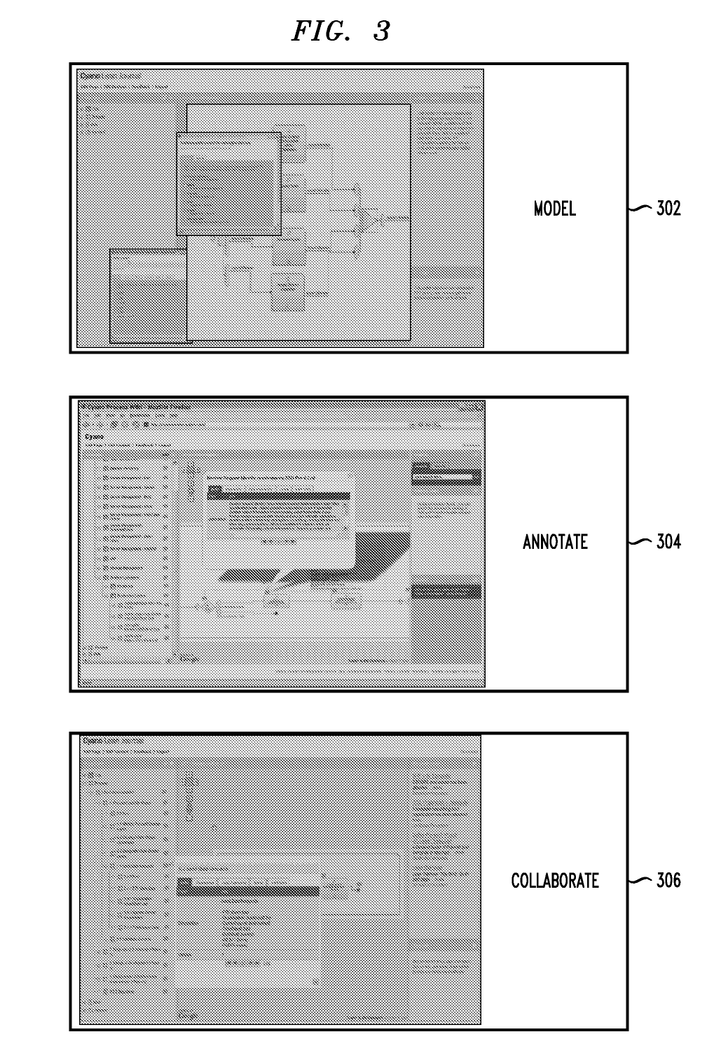

FIG. 3 is a flow diagram illustrating techniques for capturing lean processes (with lean as an exemplary illustration), according to an embodiment of the present invention. By way of illustration, FIG. 3 depicts the following steps. Step 302 includes preparing lean as a process model. Step 304 includes annotating and linking the model with all details. Step 306 includes using the model to collaborate and track progress.

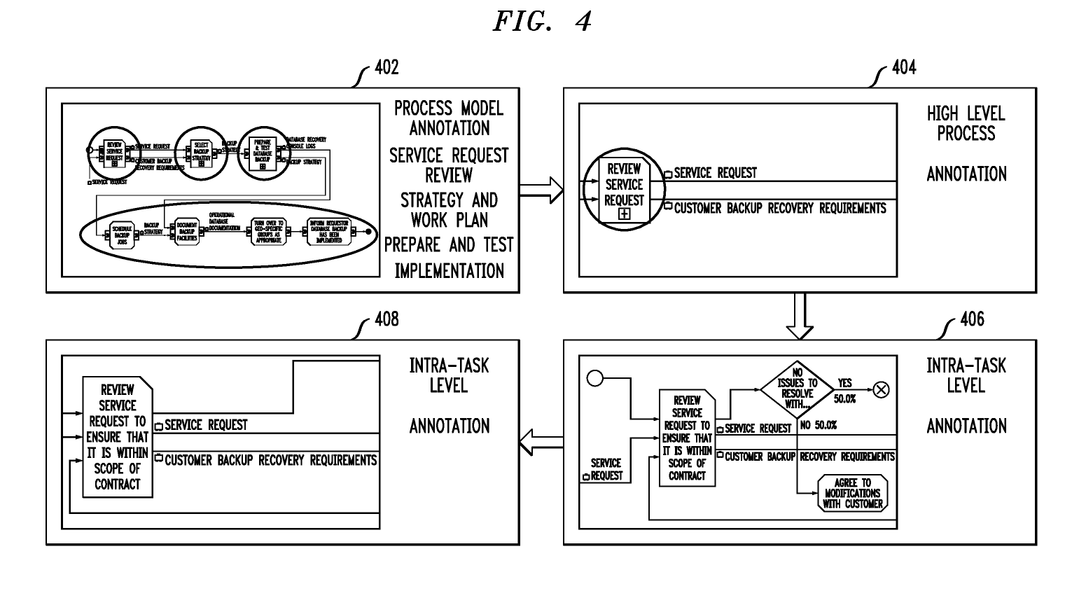

FIG. 4 is a diagram illustrating an exemplary grouping of tasks followed by enrichment (that is, annotation) stages, according to an embodiment of the present invention. A primary purpose of preparing groups include, for example, facilitating the clustering of similar types of tasks and steps within a process (as sub-processes and/or tasks) together (if there are no hard-dependencies to satisfy as far as the chain of execution steps are concerned), enabling the removal of redundant sub-processes and/or tasks, and helping to organize the process and/or process chains both at local and global levels. An examination of several captured enterprise processes as a process model reveals, irrespective of the type of process, competency or service line, that a complete process chain generally constitutes the four categories described herein as the basic steps. By introducing such a grouping concept for the processes (which is usually based on the functional stages that a process goes through before being declared as complete) brings in a number of benefits for a large number of processes and process chains. Benefits can include, for example, breaking of the complexity and functionality within a process, and enabling a minimum number of hands-off operations.

An example of annotation at a group level represents a broader sub-process commonly named as “Service Request Review.” As the name suggests, the generic nature of the sub-process can include many exercises apart from preparing the type of service request and required resources and/or personnel to carry out such an operation at a group level. Moreover, a group level annotation can also include links (such as “send service request,” “customer requirements,” etc.) as the process of establishing the channels between the sub-processes. By way of illustration, FIG. 4 depicts the elements of process model grouping 402, high-level process annotation 404, inter-task level annotation 406 and intra-task level annotation 408.

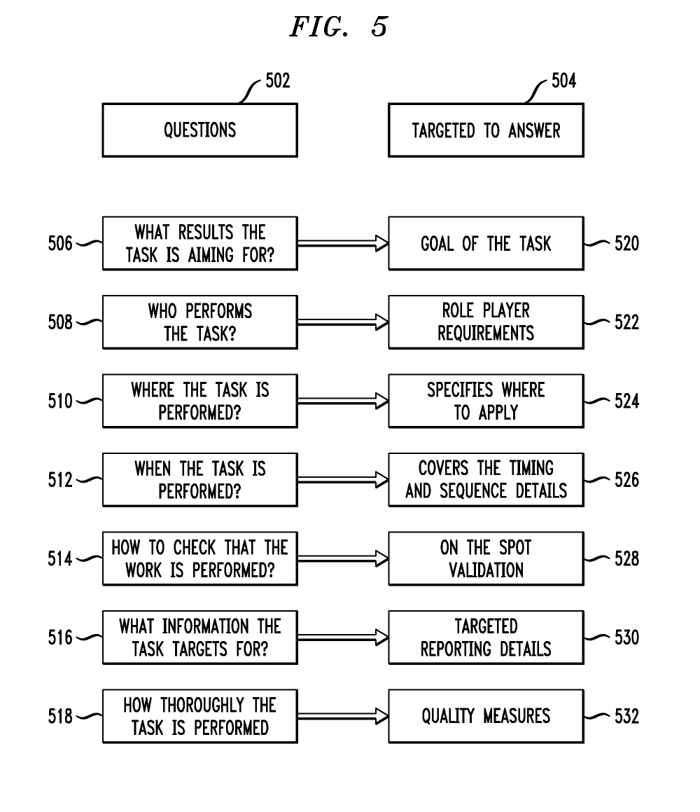

FIG. 5 is a diagram illustrating necessary criteria for process annotation, according to an embodiment of the present invention. By way of illustration, FIG. 5 depicts questions 502 targeted to corresponding answers 504. Questions 502 include the following questions. Question 506 asks what results the task is aiming for. Question 508 asks who performs the task. Question 510 asks where the task is performed. Question 512 asks when the task is performed. Question 514 asks how to check that the work is performed. Question 516 asks what information the task targets. Also, question 518 asks how thoroughly the task is performed.

As denoted by category 504, the above questions each are targeted to provide a particular answer. As such, answer 520 includes the goal of the task. Answer 522 includes the role player requirements. Answer 524 includes specifying where to apply.

Answer 526 includes covering the timing and sequence details. Answer 528 includes on-the-spot validation. Answer 530 includes targeted reporting details. Also, answer 532 includes quality measures.

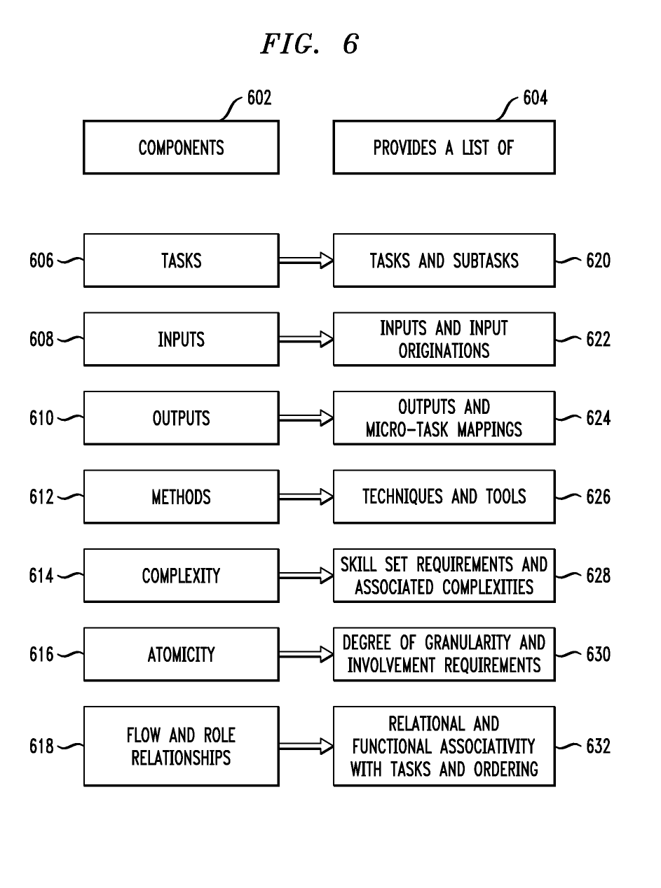

FIG. 6 is a diagram illustrating sufficient criteria for process annotation, according to an embodiment of the present invention. By way of illustration, FIG. 6 depicts a category of components 602 and a category 604 of items provided by the corresponding component. Components 602 include tasks 606, inputs 608, outputs 616, methods 612, complexity 614, atomicity 616 and flow and role relationships 618. The corresponding items provided by each corresponding component include tasks and sub-tasks 620, inputs and input originations 622, outputs and micro-task mappings 624, techniques and tools 626, skill set requirements and associated complexities 628, degree of granularity and involvement requirements 630 and relational and functional associativity with tasks and ordering 632.

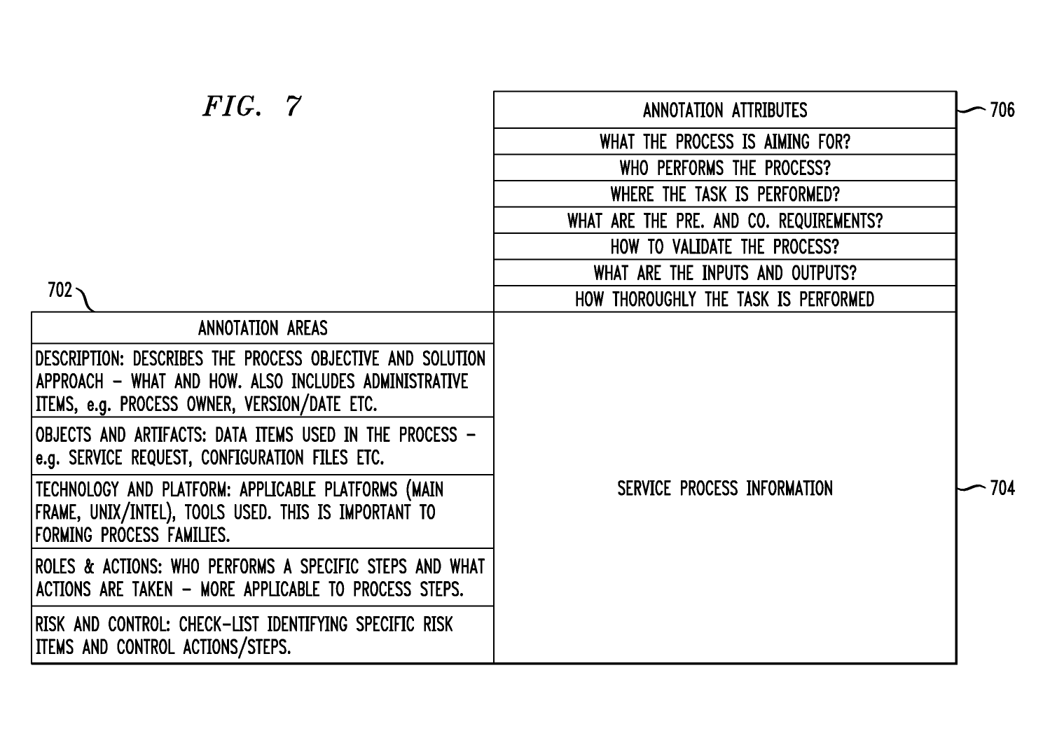

FIG. 7 is a diagram illustrating a service process annotation matrix, according to an embodiment of the present invention. By way of illustration, FIG. 7 depicts the elements of annotation areas 702, service process information 704 and annotation attributes 706. Annotation areas 702 include a description, which describes the process objective and solution approach and also includes administrative items (for example, process owner, version and/or date etc.). Annotation areas 702 also include objects and artifacts, which are data items used in the process (for example, service request, configuration files etc.).

Additionally, annotation areas 702 include technology and platforms, which detail applicable platforms (Main Frame, Unix/Intel) and tools used, for example, in forming process families. Annotation areas 702 also include roles and actions, which describe who performs a specific step and what actions are taken. Further, annotation areas 702 include risk and control, which includes a check-list identifying specific risk items and control actions and/or steps.

Annotation attributes 706 can include, for example, what the process is aiming for, who performs the process, where the task is performed, what are the pre- and co-requirements, wow to validate the process, what are the inputs and outputs, and how thoroughly the task is performed. Service process information can include, for example, a wide range of forms, charts, documents and procedures in a variety of hard and soft copy formats generally considered as input.

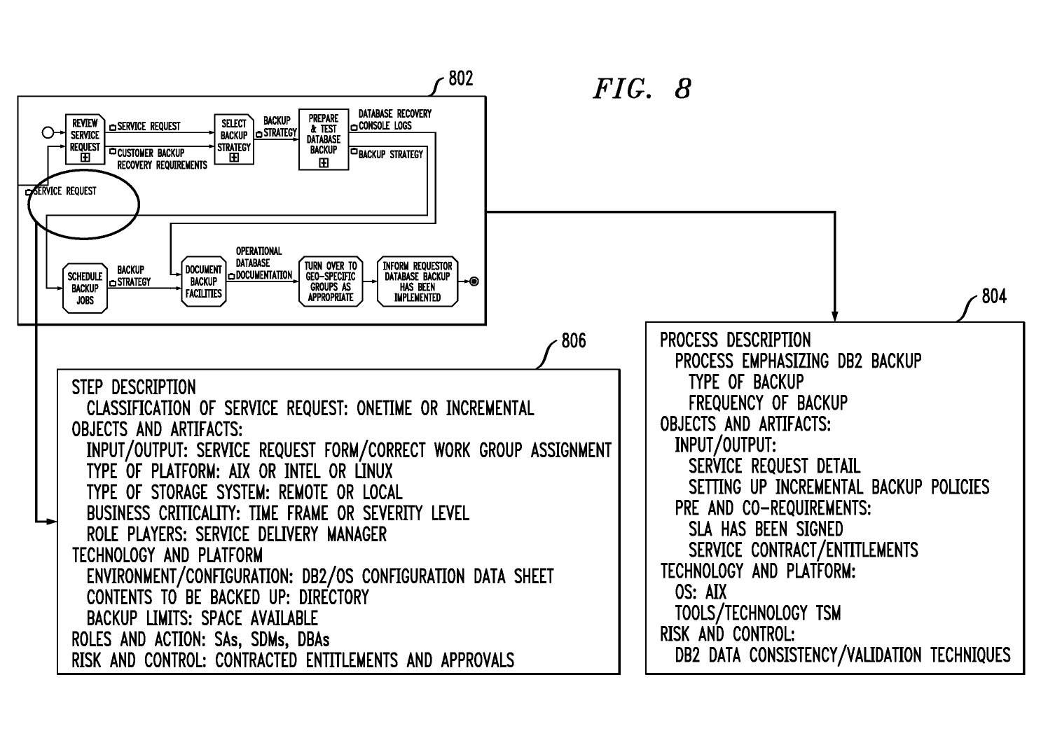

FIG. 8 is a diagram illustrating exemplary service process annotation, according to an embodiment of the present invention. By way of illustration, FIG. 8 depicts the elements of 802, 804 and 806. 802 represents the current way of representing processes as view graphs, while 804 and 806 include add-ins to the process view graphs representing overall process related annotations and sub-processes and/or task based annotations included as a part of the embodiment.

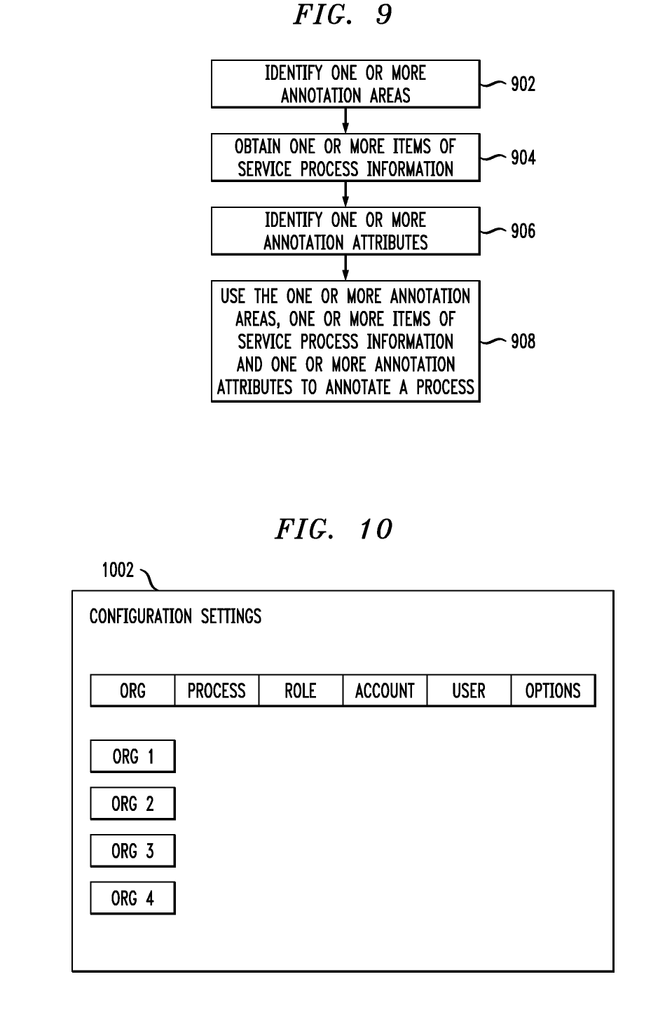

FIG. 9 is a flow diagram illustrating techniques for annotating a process, according to an embodiment of the present invention. The necessary and sufficient requirements can be, for example, pre-defined. Step 902 includes identifying one or more annotation areas. Step 904 includes obtaining one or more items of service process information. The items of service process information can include, for example, tasks and sub-processes. The tasks and sub-processes can be grouped to meet a subset of necessary and sufficient requirements, while, for example, considering the rest as optional.

Step 906 includes identifying one or more annotation attributes. Step 908 includes using the one or more annotation areas, one or more items of service process information and one or more annotation attributes to annotate a process. The techniques depicted in FIG. 9 can also include, for example, certifying that tasks and sub-processes are self-contained and/or modular in nature.

The techniques described herein can also prioritize the requirements for a task, sub-process and/or a plurality of tasks and/or processes by way of grouping necessary as well as sufficient requirements. One or more embodiments of the invention also includes, for example, automating and standardizing annotation steps for a task, sub-process or a plurality of tasks and/or sub-processes.

Additionally, the techniques depicted in FIG. 9 can also include using a set of necessary and sufficient requirements as a pre- and/or a co-requisite for process annotation and/or interactive manual preparation.

FIG. 10 is a diagram illustrating exemplary configuration settings 1002, according to an embodiment of the present invention. As an exemplary illustration, any configuration of a process can include, for example, the details of the process organization (such as, for example, org1, org2, etc.), role player and account specific details.

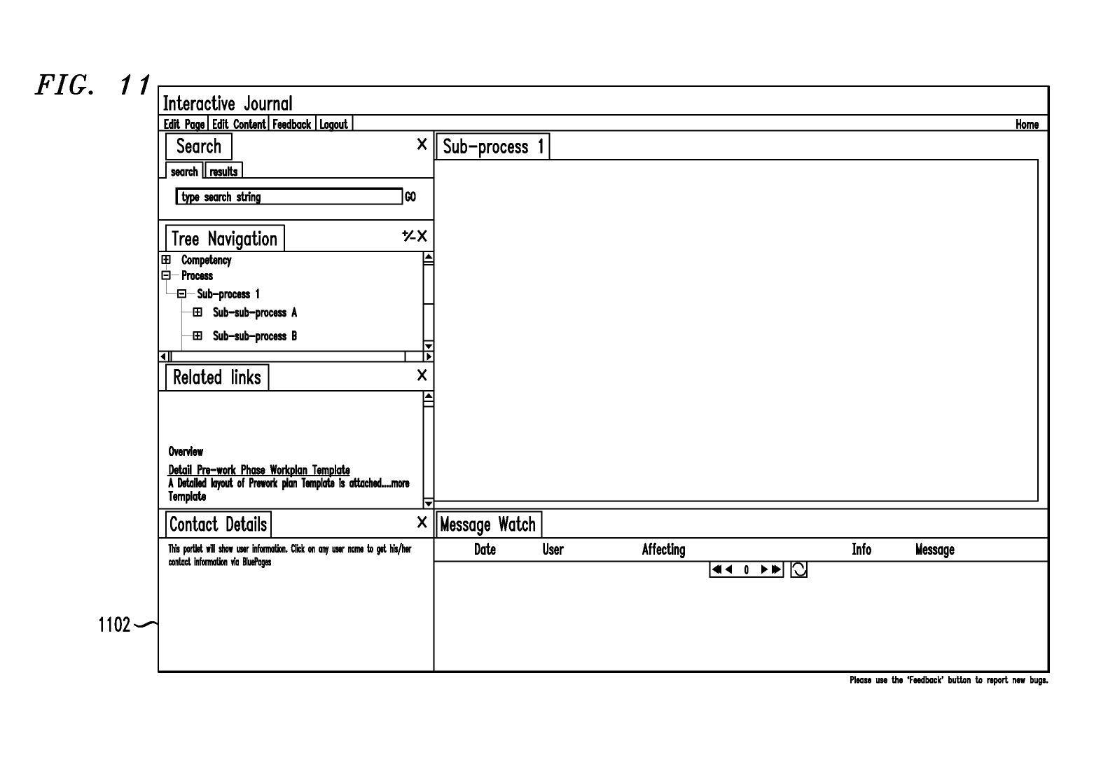

FIG. 11 is a diagram illustrating an interactive journal layout, according to an embodiment of the present invention. By way of illustration, FIG. 11 depicts a screenshot 1102 of an exemplary interactive journal layout. An interactive journal allows the users to add comments and provide opinions and suggestions based on their role in the process. As described herein, a journal entry can include, for example, the person/user who has added the inputs or comments getting recorded though logs on a transparent basis. Further, as an interactive mechanism, there are “easy to use” standard locks and authoring and updating procedures that enable every user to communicate and share the updates almost instantly without coming out of the journal.

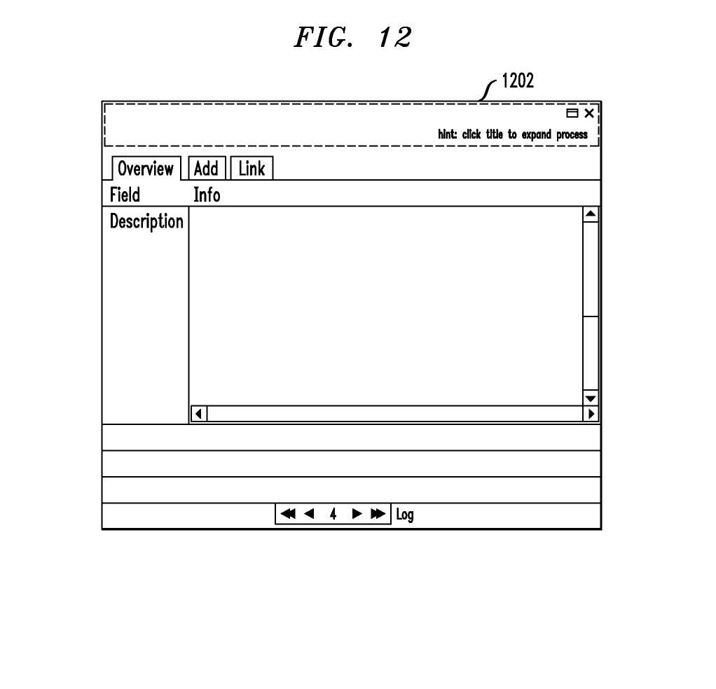

FIG. 12 is a diagram illustrating an exemplary interactive mechanism to add and delete changes with keeping a log of the changes, according to an embodiment of the present invention. By way of illustration, FIG. 12 depicts a screenshot 1202 of such an exemplary interactive mechanism.

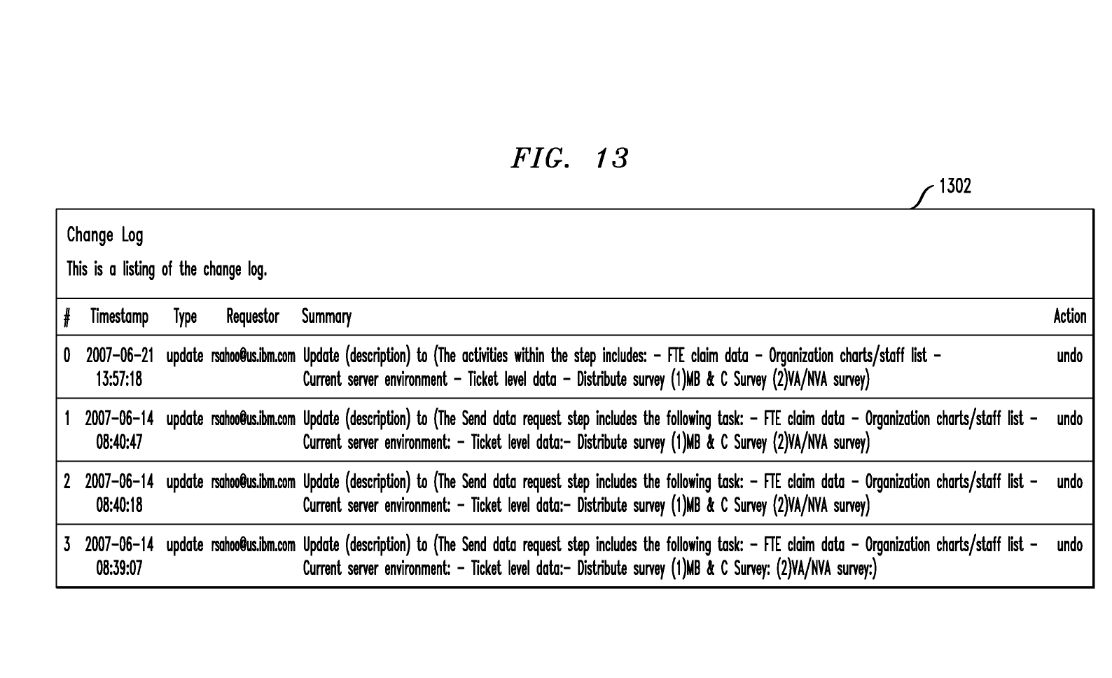

FIG. 13 is a diagram illustrating a change log representing collaborative details with actions, according to an embodiment of the present invention. By way of illustration, FIG. 13 depicts a screenshot 1302 of exemplary change log details with actions.

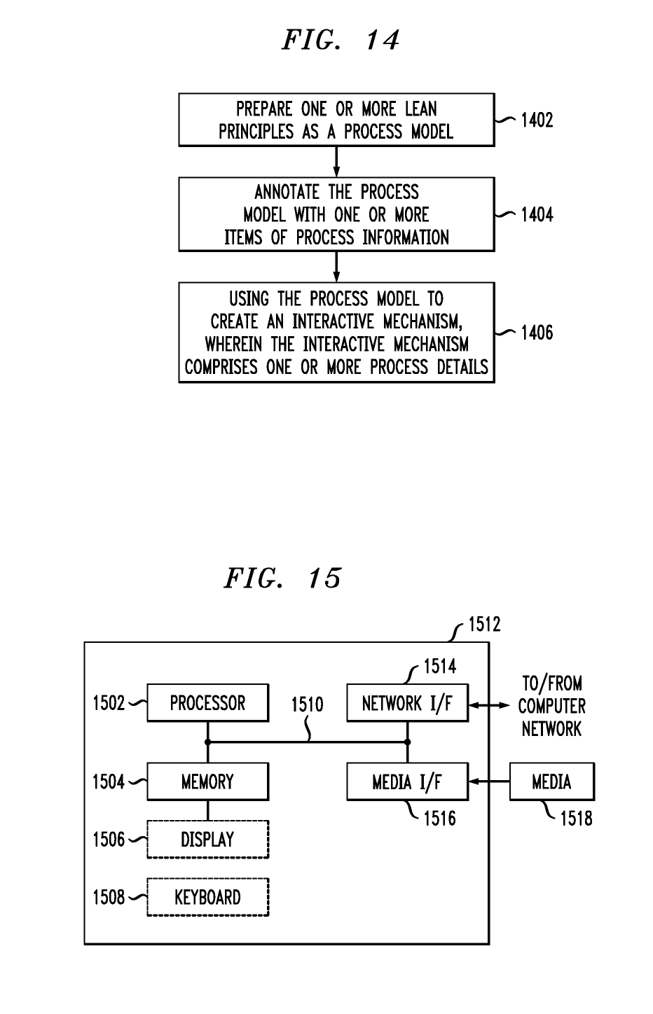

FIG. 14 is a flow diagram illustrating techniques for creating an interactive mechanism, according to an embodiment of the present invention. Step 1402 includes preparing one or more lean principles as a process model. Step 1404 includes annotating the process model with one or more items of process information. The one or more items of process information can include, for example, tasks, accounts, clusters, links, associated role player details, an input requirement, an output requirement and/or desired functions. Also, the one or more items of process information can include integrated contact information with links to role-players with organization hierarchy.

Annotating the process model with one or more items of process information can include, for example, representing tasks within a lean process in a self-contained state with input content, output content, form templates and/or account-specific requirements.

Step 1406 includes using the process model to create an interactive mechanism, wherein the interactive mechanism comprises one or more process details. The techniques depicted in FIG. 14 can also include automatically generating a report with consolidated lean review and access to input, output and delivery requirements. Additionally, an interactive journal can be generated and interactive and built-in collaborative techniques can be implemented with interfaces for collaboration and seeking assistance while responding to queries. Also, the interactive mechanism can share, deploy, track and/or implement one or more process details.

Principles of the present invention also include process annotation towards building self-contained task items. One or more embodiments of the invention annotate a task, sub-process and/or process by way of a well-defined set of necessary and/or sufficient requirements. Both the necessary and sufficient requirements provide answers to set of seven questions and seven components with three levels of details (termed as basic, modular and completeness). Tasks can be, for example, categorized within a process into four different groups, with each group emphasizing more importance to a subset of necessary and/or sufficient requirements.

An annotated task with well-defined input, output and other details (including, for example, the group to which the task belongs), makes a task (or sub-process) more modular and usable as a self-contained entity which can either be plugged-in or operationalized. A self-contained process can provide scope to automated and future optimizations.

Also, one or more embodiments of the present invention include providing a journal and publishing wiki that is sufficiently comprehensive and self-contained so as to go beyond the cross-boundary requirements to provide a reporting and auditing over and above being used as training and learning portal for new entrants at any level.

Further, the techniques described herein significantly reduce the efforts required to annotate a big list of processes which have subtle differences at task or sub-process level. Moreover, one or more embodiments of the invention cut down the duplication efforts while emphasizing a subset of requirements (both from necessary and sufficient point of view) due to the usage of grouping techniques. A standardized process annotation technique leads to automated process annotation to a maximum extent while minimizing errors and variables associated with manual annotations.

Each task becomes more modular and easily pluggable, as well as usable with a wider scope of usage. One or more embodiments of the invention also cover any new customer requirements, hence preparing as a series of pluggable tasks or sub-processes, while only concentrating and optimizing on building newly introduced tasks or sub-processes.

A variety of techniques, utilizing dedicated hardware, general purpose processors, software, or a combination of the foregoing may be employed to implement the present invention. At least one embodiment of the invention can be implemented in the form of a computer product including a computer usable medium with computer usable program code for performing the method steps indicated. Furthermore, at least one embodiment of the invention can be implemented in the form of an apparatus including a memory and at least one processor that is coupled to the memory and operative to perform exemplary method steps.

At present, it is believed that the preferred implementation will make substantial use of software running on a general-purpose computer or workstation. With reference to FIG. 15, such an implementation might employ, for example, a processor 1502, a memory 1504, and an input and/or output interface formed, for example, by a display 1506 and a keyboard 1508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input and/or output interface” as used herein, is intended to include, for example, one or more mechanisms for inputting data to the processing unit (for example, mouse), and one or more mechanisms for providing results associated with the processing unit (for example, printer). The processor 1502, memory 1504, and input and/or output interface such as display 1506 and keyboard 1508 can be interconnected, for example, via bus 1510 as part of a data processing unit 1512. Suitable interconnections, for example via bus 1510, can also be provided to a network interface 1514, such as a network card, which can be provided to interface with a computer network, and to a media interface 1516, such as a diskette or CD-ROM drive, which can be provided to interface with media 1518.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and executed by a CPU. Such software could include, but is not limited to, firmware, resident software, microcode, and the like.

Furthermore, the invention can take the form of a computer program product accessible from a computer-usable or computer-readable medium (for example, media 1518) providing program code for use by or in connection with a computer or any instruction execution system. For the purposes of this description, a computer usable or computer readable medium can be any apparatus for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory (for example, memory 1504), magnetic tape, a removable computer diskette (for example, media 1518), a random access memory (RAM), a read-only memory (ROM), a rigid magnetic disk and an optical disk. Current examples of optical disks include compact disk-read only memory (CD-ROM), compact disk-read and/or write (CD-R/W) and DVD.

A data processing system suitable for storing and/or executing program code will include at least one processor 1502 coupled directly or indirectly to memory elements 1504 through a system bus 1510. The memory elements can include local memory employed during actual execution of the program code, bulk storage, and cache memories which provide temporary storage of at least some program code in order to reduce the number of times code must be retrieved from bulk storage during execution.

Input and/or output or I/O devices (including but not limited to keyboards 1508, displays 1506, pointing devices, and the like) can be coupled to the system either directly (such as via bus 1510) or through intervening I/O controllers (omitted for clarity).

Network adapters such as network interface 1514 may also be coupled to the system to enable the data processing system to become coupled to other data processing systems or remote printers or storage devices through intervening private or public networks. Modems, cable modem and Ethernet cards are just a few of the currently available types of network adapters.

In any case, it should be understood that the components illustrated herein may be implemented in various forms of hardware, software, or combinations thereof, for example, application specific integrated circuit(s) (ASICS), functional circuitry, one or more appropriately programed general purpose digital computers with associated memory, and the like. Given the teachings of the invention provided herein, one of ordinary skill in the related art will be able to contemplate other implementations of the components of the invention.

At least one embodiment of the invention may provide one or more beneficial effects, such as, for example, significantly cutting down the time needed to implement lean through standardized step by step evaluation, annotation and review techniques.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for creating an interactive mechanism, comprising the steps of:
preparing one or more lean principles as a process model;
annotating the process model with one or more items of process information; and
using the process model to create an interactive mechanism, wherein the interactive mechanism comprises one or more process details.

2. The method of claim 1, wherein the one or more items of process information comprises at least one of one or more tasks, one or more accounts, one or more clusters, one or more links, one or more associated role player details, an input requirement, an output requirement and one or more desired functions.

3. The method of claim 1, wherein annotating the process model with one or more items of process information comprises representing one or more tasks within a lean process in a self-contained state with at least one of input content, output content, one or more form templates and one or more account-specific requirements.

4. The method of claim 1, further comprising automatically generating a report with consolidated lean review and access to one or more input, output and delivery requirements.

5. The method of claim 1, wherein the one or more items of process information comprises integrated contact information with one or more links to one or more role-players with organization hierarchy.

6. The method of claim 1, further comprising generating an interactive journal.

7. The method of claim 1, wherein the interactive mechanism comprises at least one of sharing, deploying, tracking and implementing one or more process details.

8. A method for annotating a process, comprising the steps of:
identifying one or more annotation areas;
obtaining one or more items of service process information;
identifying one or more annotation attributes; and
using the one or more annotation areas, one or more items of service process information and one or more annotation attributes to annotate a process.

9. The method of claim 8, further comprising using a set of one or more necessary and sufficient requirements as at least one of a pre- and a co-requisite for at least one of process annotation and interactive manual preparation.

10. The method of claim 9, wherein the one or more necessary and sufficient requirements are pre-defined.

11. The method of claim 8, wherein the one or more items of service process information comprises at least one of one or more tasks and one or more sub-processes.

12. The method of claim 11, wherein the at least one of one or more tasks and one or more sub-processes are grouped to meet a subset of one or more necessary and sufficient requirements.

13. The method of claim 11, further comprising certifying that the at least one of one or more tasks and one or more sub-processes are self-contained.

14. The method of claim 11, further comprising certifying that the at least one of one or more tasks and one or more sub-processes are modular in nature.

15. A computer program product comprising a computer readable medium having computer readable program code for creating an interactive mechanism, said computer program product including:
computer readable program code for preparing one or more lean principles as a process model;
computer readable program code for annotating the process model with one or more items of process information; and
computer readable program code for using the process model to create an interactive mechanism, wherein the interactive mechanism comprises one or more process details.

16. The computer program product of claim 15, wherein the computer readable code for annotating the process model with one or more items of process information comprises computer readable program code for representing one or more tasks within a lean process in a self-contained state with at least one of input content, output content, one or more form templates and one or more account-specific requirements.

17. The computer program product of claim 15, wherein the interactive mechanism comprises at least one of sharing, deploying, tracking and implementing one or more process details.

18. The computer program product of claim 15, further comprising computer readable program code for generating an interactive journal.

19. An apparatus for creating an interactive mechanism, comprising:
a memory; and
at least one processor coupled to said memory and operative to:
prepare one or more lean principles as a process model;
annotate the process model with one or more items of process information; and
use the process model to create an interactive mechanism, wherein the interactive mechanism comprises one or more process details.

20. The apparatus of claim 19, wherein in the at least one processor coupled to said memory and operative to annotate the process model with one or more items of process information, the at least one processor coupled to said memory is further operative to:
represent one or more tasks within a lean process in a self-contained state with at least one of input content, output content, one or more form templates and one or more account-specific requirements.

21. The apparatus of claim 19, wherein the interactive mechanism comprises at least one of sharing, deploying, tracking and implementing one or more process details.

22. The apparatus of claim 19, wherein the at least one processor coupled to said memory is further operative to generate an interactive journal.

23. A computer pro-ram product comprising a computer readable medium having computer readable program code for annotating a process, said computer program product including:
computer readable program code for identifying one or more annotation areas;
computer readable program code for obtaining one or more items of service process information;
computer readable program code for identifying one or more annotation attributes; and
computer readable program code for using the one or more annotation areas, one or more items of service process information and one or more annotation attributes to annotate a process.

24. The computer program product of claim 23, further comprising computer readable program code for using a set of one or more necessary and sufficient requirements as at least one of a pre- and a co-requisite for at least one of process annotation and interactive manual preparation.

25. The computer program product of claim 23, wherein the one or more items of service process information comprise at least one of one or more tasks and one or more sub-processes.
